(19) United States
(12) Patent Application Publication
(10) Pub. No.: US 2016/0113080 A1
(43) Pub. Date: Apr. 21, 2016

(54) LIGHT-EMITTING DEVICE CAPABLE OF ADJUSTING BRIGHTNESS

(71) Applicant: PROLIGHT OPTO TECHNOLOGY CORPORATION, Taoyuan County (TW)

(72) Inventors: CHEN-LUN HSING CHEN, TAOYUAN COUNTY (TW); JUNG-HAO HUNG, TAOYUAN COUNTY (TW)

(21) Appl. No.: 14/518,018

(22) Filed: Oct. 20, 2014

(51) Int. Cl. H05B 33/08

(52) U.S. Cl. CPC H05B 33/0824; H05B 33/0845

(57) ABSTRACT

The present invention provides a light-emitting device capable of adjusting brightness. A plurality of light-emitting regions is disposed on a substrate. A power control module is connected electrically to the plurality of light-emitting regions and an input power source. The power control module converts the input power as a plurality of supply power sources, which turn on the plurality of light-emitting diodes in different regions and thus enabling them to emit light. Thereby, the light-emitting regions, and hence the brightness, can be adjusted according to the usage requirements.

### FIELD OF THE INVENTION

The present invention relates generally to a light-emitting device, and particularly to a light-emitting device capable of adjusting brightness.

### BACKGROUND OF THE INVENTION

Owing to gradual deficiency of modern petrochemical energy, the demand for power saving products increases day by day and thus urging significant progress in light-emitting diode (LED) technologies. Given the unstable price of petroleum, countries in the world delve into the development of power saving products aggressively. LEDs have the advantages of lightness, long lifetime, saving power, fast switching speed, monochromaticity, and high reliability. In the growing trend of saving power and reducing carbon emission, the lighting market of LED expands progressively. Furthermore, LEDs have replaced traditional light sources including cold-cathode fluorescent tubes, halogen lamps, and incandescent lamps. Nonetheless, LEDs still have the drawback of lower light-emitting efficiency than traditional light sources. For outdoor lighting equipment, high-voltage LEDs have greater brightness, and hence they can meet modern lighting requirements. Thereby, high-voltage LEDs are widely developed for lighting applications.

Nonetheless, no matter normal LEDs or high-voltage LEDs, a single threshold voltage is used for turning on and emitting light. That is to say, once a single voltage higher than the threshold value is supplied, LEDs will emit light. Consequently, the driving circuit of normal LEDs can only drive LEDs and provide a single brightness value. For a single lighting apparatus with LEDs, only a single brightness value is provided. It cannot provide various brightness values according to the requirements for brightness. Thereby, no matter for a single user or multiple users, only a single brightness value is provided.

Moreover, the general driving circuits in the market are only suitable for supplying power for driving LEDs but not further controlling the light-emitting regions of LEDs or the overall light-emitting area of light-emitting devices for adjusting the brightness of the environment or saving power. As a consequence, current light-emitting devices having LEDs can save power through light-emitting efficiency only.

Accordingly, the present invention provides a light-emitting device capable of adjusting brightness, which can provide different brightness as well as changing the light-emitting region.

### SUMMARY

An objective of the present invention is to provide a light-emitting device capable of adjusting brightness, which uses different power sources to drive light-emitting regions for satisfying different requirements in brightness.

In order to achieve the objective and effect as described above, the present invention discloses a light-emitting device capable of adjusting brightness, which comprises a substrate, a first light-emitting region, a second light-emitting region, and a power control module. The first and second light-emitting regions are disposed on the substrate. The power control module is connected electrically to the first and second light-emitting regions. By connecting electrically the power control module to a power supply unit, and the input power source of the power supply unit is switched between a first supply power source and a second supply power source. The first supply power source drives the first light-emitting region to emit light; the second supply power source drives the first and second light-emitting regions to emit light. Thereby, the first and second light-emitting regions can emit light according to different requirements in brightness.

### BRIEF DESCRIPTION OF THE DRAWINGS

FIG. 1 shows a schematic diagram of the circuit according to a preferred embodiment of the present invention;

FIG. 2A shows a schematic diagram of the distribution of the light-emitting regions according to another preferred embodiment of the present invention;

FIG. 2B shows a schematic diagram of the circuit according to another preferred embodiment of the present invention;

FIG. 3A shows a schematic diagram before the input power source is rectified according to another preferred embodiment of the present invention;

FIG. 3B shows a schematic diagram after the input power source is rectified according to another preferred embodiment of the present invention;

FIG. 4A shows a schematic diagram of increasing voltage levels according to another preferred embodiment of the present invention;

FIG. 4B shows a schematic diagram of variation in the light-emitting regions according to another preferred embodiment of the present invention;

FIG. 5A shows a schematic diagram of decreasing voltage levels according to another preferred embodiment of the present invention;

FIG. 5B shows a schematic diagram of variation in the light-emitting regions according to another preferred embodiment of the present invention;

FIG. 6 shows a schematic diagram of the distribution of the light-emitting regions according to another preferred embodiment of the present invention;

FIG. 7A shows a schematic diagram of increasing voltage levels according to another preferred embodiment of the present invention;

FIG. 7B shows a schematic diagram of variation in the light-emitting regions according to another preferred embodiment of the present invention;

FIG. 8A shows a schematic diagram of decreasing voltage levels according to another preferred embodiment of the present invention; and

FIG. 8B shows a schematic diagram of variation in the light-emitting regions according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

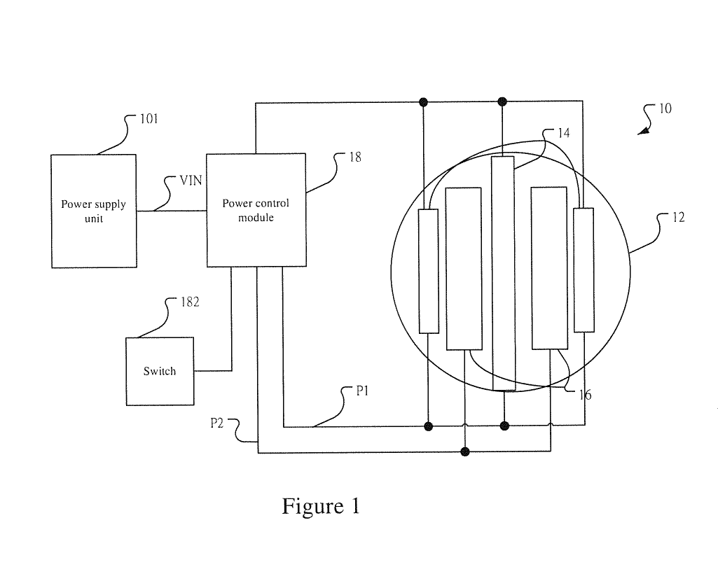

Please refer to FIG. 1, which shows a schematic diagram of the circuit according to a preferred embodiment of the present invention. As shown in the figure, the light-emitting device 1 according to the present invention comprises a power supply unit 11, a substrate 12, a plurality of first light-emitting regions 14, a plurality of second light-emitting regions 16, and a power control module 18. The plurality of first light-emitting regions 14 and the plurality of second light-emitting regions 16 are disposed on the substrate 12 and interlaced. In addition, the plurality of first light-emitting regions 14 and the plurality of second light-emitting regions 16 are connected electrically in series. The plurality of first light-emitting regions 14 and the plurality of second light-emitting regions 16 include a plurality of LEDs, respectively. The method for disposing LEDs is disclosed in the prior art. Hence, the details will not be described again. The power control module 18 is disposed between the power supply unit 12 and the light-emitting regions 14, 16. The power supply unit 11 supplies an input power source VIN to the power control module 18, which then converts the input power source VIN as a first supply power source P1 and a second supply power source P2. Besides, a switch 182 controls the power control module 18.

The first supply power source P1 drives the first light-emitting regions to emit light; the second supply power source P2 drives the first and second light-emitting regions 14, 16 to emit light concurrently. The input power source according to the present embodiment is a DC power source. Thereby, the first and second supply power sources are also DC power sources. Nonetheless, the present invention is not limited to this embodiment. The supply power sources can be replaced by AC (alternate-current) power sources for being compatible with modern requirements by electricity grid. Moreover, the first and second light-emitting regions 14, 16 can be disposed symmetrically or asymmetrically. In other words, when the plurality of first light-emitting regions 14 are disposed symmetrically, the plurality of second light-emitting regions 16 are also disposed symmetrically; when the plurality of first light-emitting regions 14 are disposed asymmetrically, the plurality of second light-emitting regions 16 are disposed asymmetrically as well.

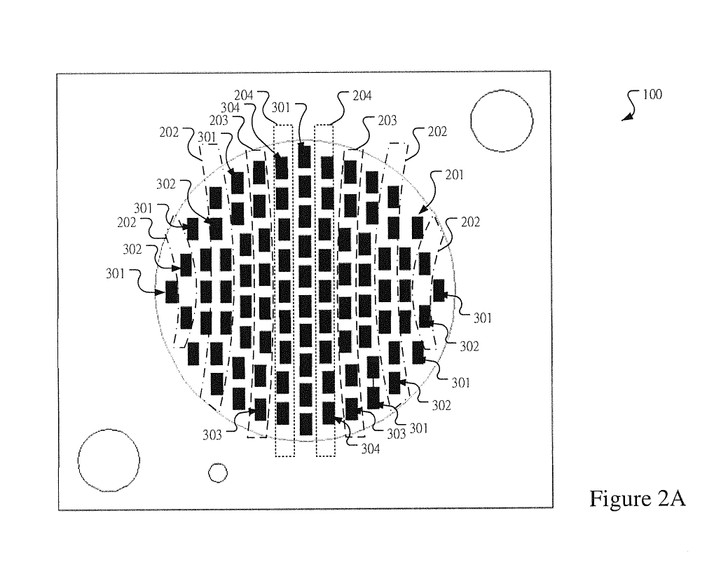

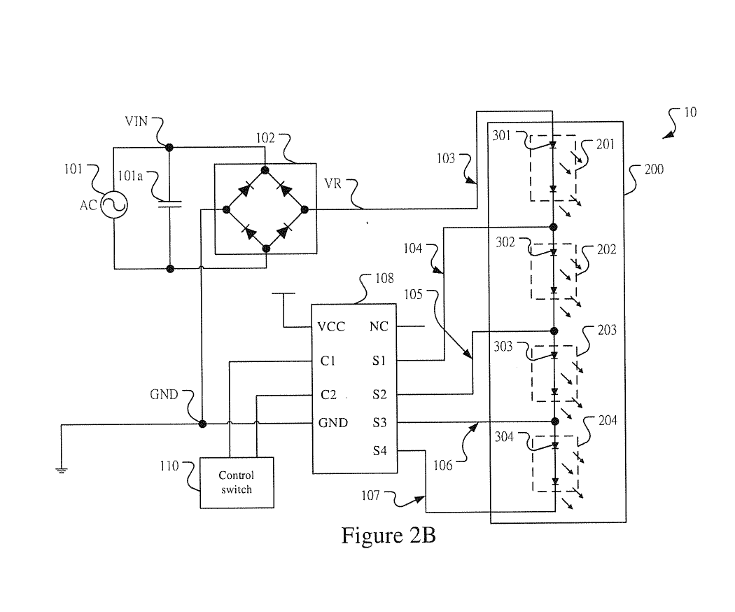

Please refer to FIG. 2A and FIG. 2B, which show schematic diagrams of the distribution of the light-emitting regions and the circuit according to another preferred embodiment of the present invention. As shown in the figures, the light-emitting device 100 according to the present invention further comprises a third light-emitting regions and a fourth light-emitting region. As shown in FIG. 2A, the light-emitting device 10 according to the present invention comprises a power control module 108, a substrate 200, and a plurality of light-emitting regions 201˜204. The light-emitting regions according to the present embodiment are divided into a first light-emitting region 201, a second light-emitting region 202, a third light-emitting region 203, and a fourth light-emitting region 204. The power control module 108 includes a first control pin C1, a second control pin C2, a first select pin S1, a second select pin S2, a third select pin S3, and a fourth select pin S4 for corresponding to the regions on the substrate 200. According to the present embodiment, a set of first LEDs 301, a set of second LEDs 302, a set of third LEDs 303, and a set of fourth LED 304 are taken as an example for description for corresponding to the regions on the substrate 200. The power control module 108 and the LEDs 301˜304 are connected in parallel with a capacitor 101a for connecting electrically to the power supply unit 101. In addition, the present embodiment further comprises a bridge rectifying unit 102.

The first to fourth light-emitting regions 201˜204 include a plurality of LEDs 301˜304, respectively, That is to say, the plurality of first LEDs 301 are disposed in the first light-emitting region 201; the plurality of second LEDs 302 are disposed in the second light-emitting region 202; the plurality of third LEDs 303 are disposed in the third light-emitting region 203; and the plurality of fourth LEDs 304 are disposed in the fourth light-emitting region 204. As shown in FIG. 2A, the second to fourth light-emitting regions 202˜204 are framed regions. The only unframed region is the first light-emitting region 201. The first to fourth light-emitting regions 201˜204 are interlaced. Besides, the first to fourth light-emitting regions 201˜204 can be disposed symmetrically or asymmetrically as well.

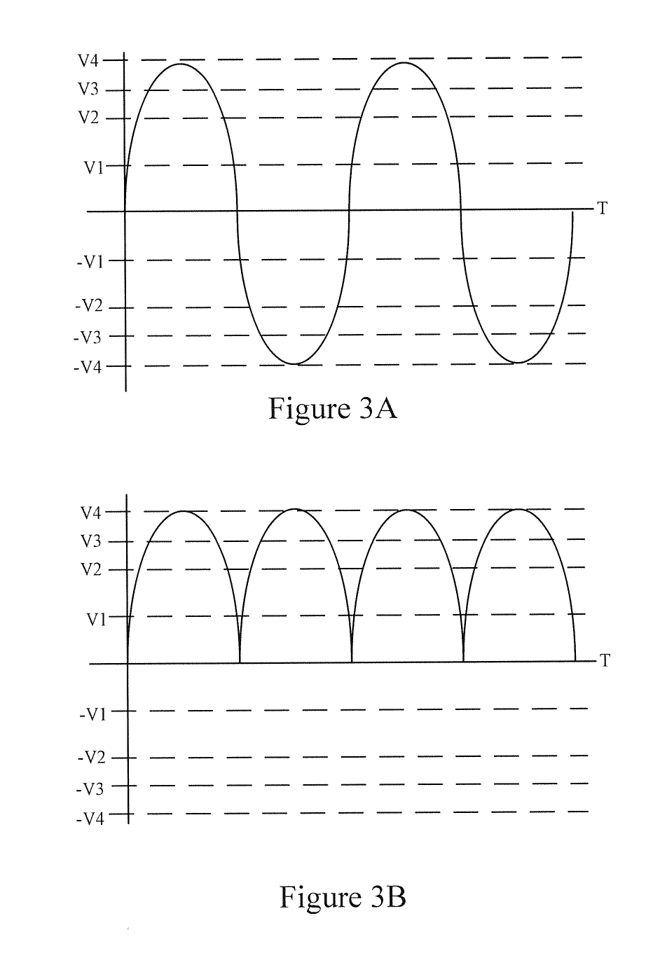

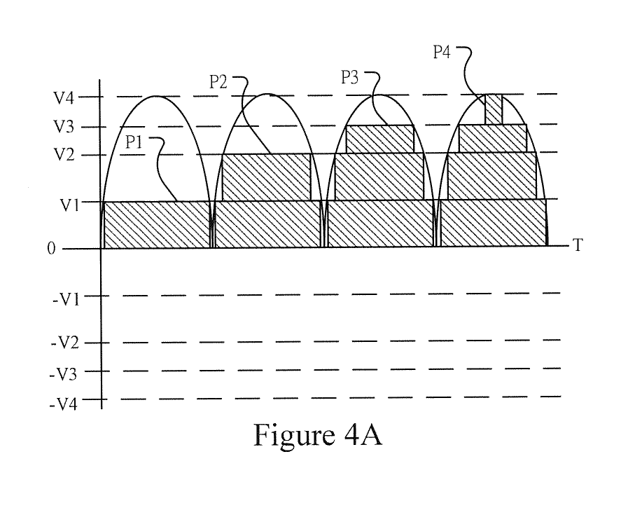

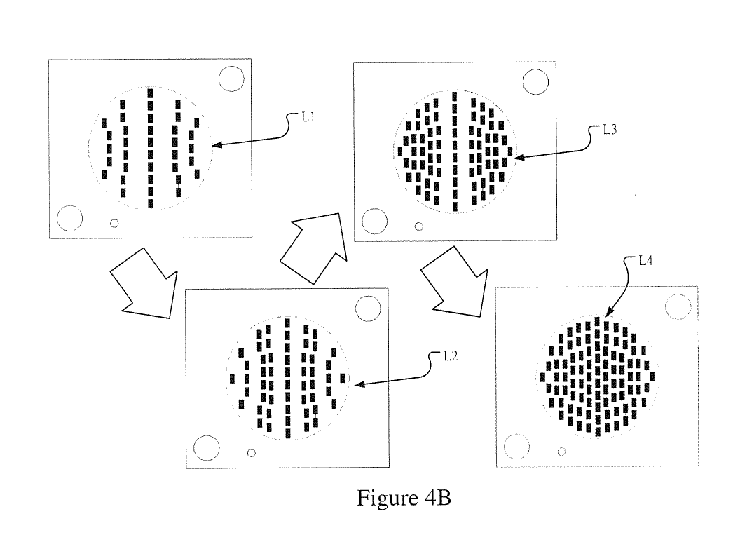

The power control module 108 is connected electrically to the plurality of LEDs 301˜304 and the power supply unit 101. The power control module 108 converts the input power source as a plurality of supply power sources having different voltage levels. As shown in FIGS. 3A and 4A, the voltage levels can include the first voltage level V1, the second voltage level V2, the third voltage level V3, and the fourth voltage level V4. The voltage levels V1˜V4 of the plurality of supply power sources turn on the plurality of LEDs 301˜304 in the different regions 201˜204 and drive them to emit light. The present embodiment further comprises a control switch 110 connected electrically to the first control pin C1 and the second control pin C2 of the power control module 108 for switching among the first select pin S1 to the fourth select pin S4, and thus switching among the first voltage level V1 to the fourth voltage level V4. The capacitor 101a is connected between and parallel with the power supply unit 101 and the power control module 108. The capacitor 101a is charged and discharged via the input power source VIN of the power supply unit 10 for filtering noise from the input power source VIN. Besides, it also boosts voltage the input voltage VIN supplying to the light-emitting device 10.

Moreover, because the input power source VIN according to the present embodiment is an AC power source, the present embodiment further uses the bridge rectifying unit 102 to rectify the input power source VIN. The bridge rectifying unit 102 is disposed between the power supply unit 101 and the LEDs 301˜304 as well as between the power supply unit 101 and the power control module 108. As shown in FIG. 3A. The power supply unit 101 provides the input power source with positive and negative phases and thus forming a continuous curve. The LEDs 301˜304 according to the present embodiment are high-voltage LEDs. They cannot emit light at negative voltage levels. Accordingly, the bridge rectifying unit 102 is used for rectifying the input power source VIN to a rectified power source VR, as shown in FIG. 3B. The rectified power source VR is always located in the positive phase, which enables the LEDs 301˜304 to emit light continuously. In addition, the power control module 108 is used for adjusting to power sources having different voltage levels.

Please refer to FIG. 4A and FIG. 4B, which show schematic diagrams of increasing voltage levels and variation in the light-emitting regions according to another preferred embodiment of the present invention. As shown in FIG. 4A, because the LEDs according to the present invention are disposed in different regions, power sources having different voltage levels are required for driving LEDs in different regions to emit light.

Because the LEDs 301˜304 in different regions according to the present embodiment are connected in series, rectified power sources with different voltage levels should be used for driving them. In other words, the first supply power source P1 is used for driving the first light-emitting region 201 to emit light and form a first light-emitting pattern L1; the second supply power source P2 is used for driving the first light-emitting region 201 and the second light-emitting region 202 to emit light concurrently and form a second light-emitting pattern L2; the third supply power source P3 is used for driving the first light-emitting region 201, the second light-emitting region 202, and the third light-emitting region 203 to emit light concurrently and form a third light-emitting pattern L3; and the fourth supply power source P4 is used for driving the LEDs in all of the regions, namely, the first to fourth light-emitting regions 201˜204, to emit light concurrently and form a fourth light-emitting pattern L4. Owing to the increase of the light-emitting regions, the color temperature of the light-emitting device 10 is increased from a first color temperature to a fourth color temperature. For example, the 3000K cold white light is increased to the 4500K, 6000K, and 7500K warm white light gradually.

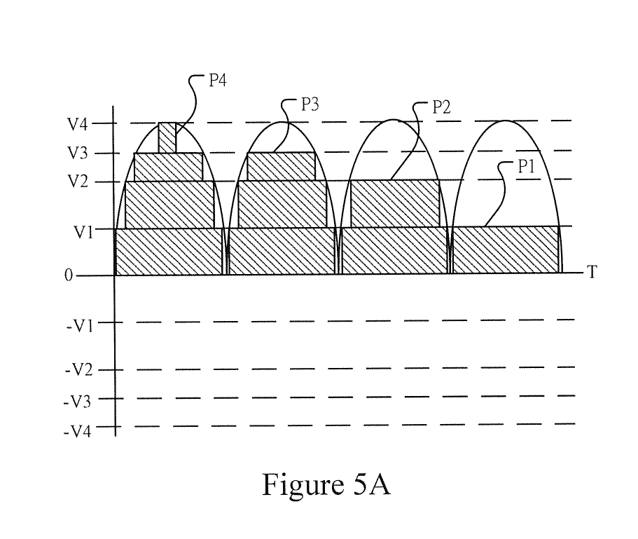

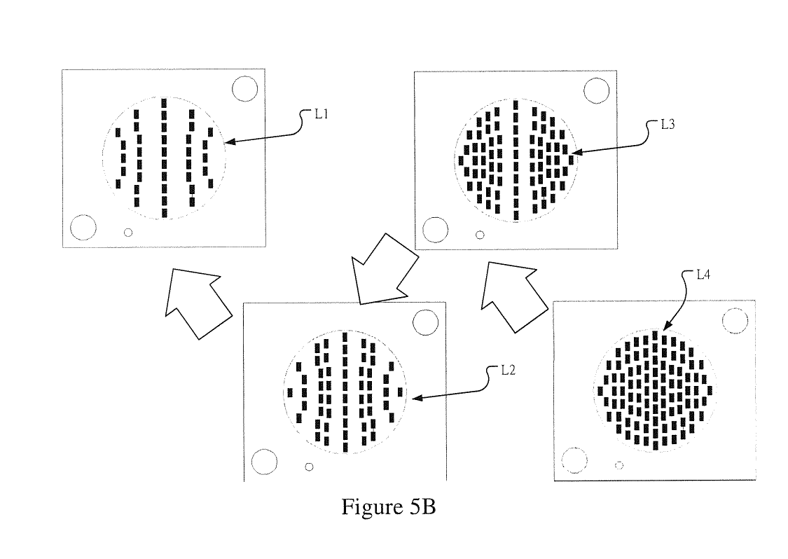

Please refer to FIG. 5A and FIG. 5B, which show schematic diagrams of decreasing voltage levels and variation in the light-emitting regions according to another preferred embodiment of the present invention. The difference between FIG. 4A and FIG. 5A is that the former is increasing voltage levels while the latter is decreasing. As shown in the figures, corresponding to the decreasing voltage levels, the supply power source is changed from the fourth supply power source P4 to the first supply power source P1 gradually. Thereby, the light-emitting regions of the LEDs firstly include the first to fourth light-emitting regions 201˜204 by supplied the fourth supply power source P4, and then reduce gradually to the first light-emitting region 201 supplied by the first supply power source P1 only. That is to say, the light-emitting pattern is changed from the fourth light-emitting pattern L4 to the first light-emitting pattern L1 gradually.

The above embodiment of decreasing voltage levels is used for describing different light-emitting regions caused by the variation in voltage level. Nonetheless, the light-emitting device 10 according to the present invention is not limited to only decreasing or increasing voltage levels for driving the LEDs in different light-emitting regions to emit light. As shown in FIG. 1, according to the requirement, the power control module 108 adjusts the path by which the light-emitting regions and the power supply unit 101 form a circuit. In general, the maximum light-emitting region is set when the power control module 108 is switched to turn on the fourth select pin S4. Thereby, the first path 103 and the fifth path 107 are connected in series with the first to fourth light-emitting regions 201˜204 for connecting electrically to the power supply unit 101. Then, light can be emitted using the rectified power source VR supplied by the bridge rectifying unit 120. The fourth supply power source P4 is equal to the rectified power source VR. That is to say, the LEDs 301˜304 of the first to fourth light-emitting regions 201˜204 emit light using the fourth supply power source P4.

Besides, the power control module 108 can switch to make the first path 103 and the second path 104 connected in series with the first light-emitting region 201. Alternatively, the first path 103 and the third path 105 can connect in series with the first and second light-emitting regions 201,202. Alternatively, the first path 103 and the fourth path 106 can connect in series with the first to third light-emitting regions 201˜203. Thereby, depending on the usage requirements, for example, color temperature and brightness, the LEDs in different light-emitting regions can be arranged to emit light. Consequently, the LEDs 301˜304 can deliver different light-emitting patterns. For example, the brightest light-emitting pattern is the fourth light-emitting pattern L4; the least bright light-emitting pattern is the first light-emitting pattern L1.

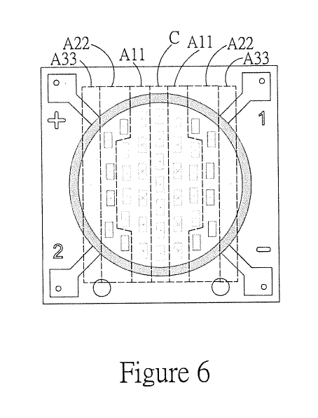

Please refer to FIG. 6, which shows a schematic diagram of the distribution of the light-emitting regions according to another preferred embodiment of the present invention. As shown in the figure, the light-emitting device 10 according to the present invention can assign the first light-emitting region 201 as the central light-emitting region C, the second light-emitting regions 202 as a symmetrical first pair of light-emitting regions A11, the third light-emitting regions 203 as a symmetrical second pair of light-emitting regions A22, and the fourth light-emitting regions 204 as a symmetrical third pair of light-emitting regions A33. According to the present embodiment, three pairs of light-emitting regions are disposed symmetrically. Nonetheless, the present invention is not limited to the embodiment. At least one pair of light-emitting regions or even more pairs of light-emitting regions can be disposed according to the requirement. In addition, the first pair of light-emitting regions A11 and the central light-emitting region C emit light concurrently. The first pair of light-emitting regions A11 emit light symmetrically. The second pair of light-emitting regions A22 emit light symmetrically. The third pair of light-emitting regions A33 emit light symmetrically. Thereby, the light-emitting device 10 according to the present invention can further provide at least a pair of light-emitting regions for emitting light. The details will be described as follows.

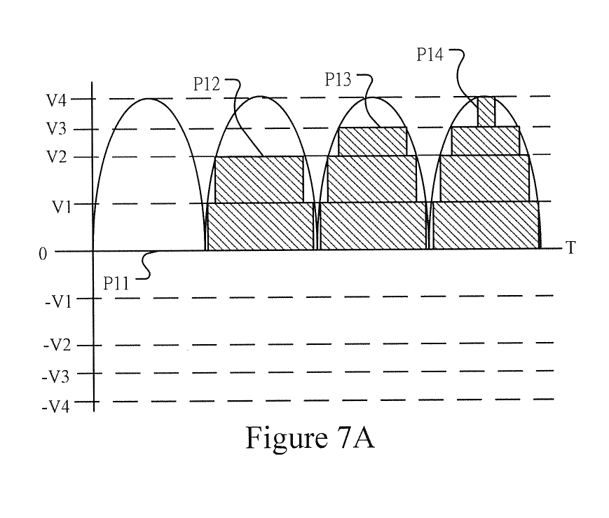

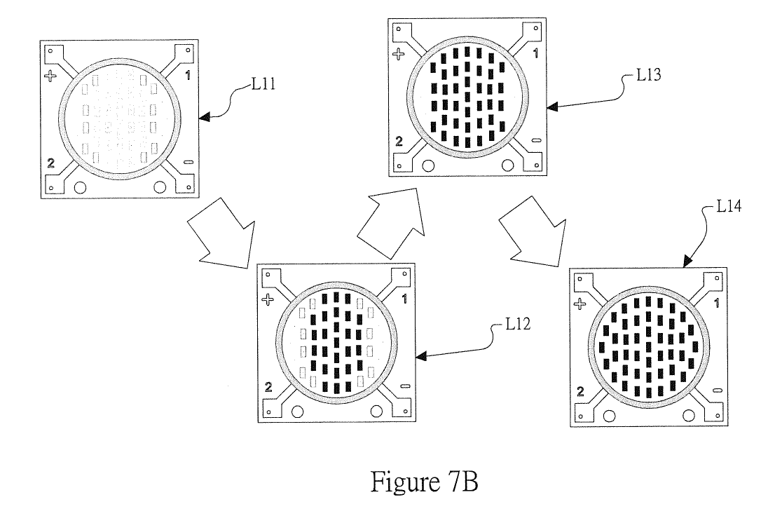

Please refer to FIG. 7A and FIG. 7B, which show schematic diagrams of increasing voltage levels and variation in the light-emitting regions according to another preferred embodiment of the present invention. The difference between FIG. 5B and FIG. 7B is that the light-emitting regions in FIG. 5B are interlaced while those in FIG. 7B are arranged symmetrically. The light-emitting patterns L11˜L14 in FIG. 7B correspond to the increasing voltage levels P11˜P14 shown in FIG. 7A.

According to the present embodiment, the LEDs 301˜304 in different regions are connected in series. Thereby, the rectified power sources having different voltage levels V1˜V4 are used for driving the LEDs 301˜304 in different regions. That is to say, the first supply power source P11 does not drive any light-emitting region and forming the first light-emitting pattern L11. The second supply power source P12 drives the first and second light-emitting regions 201, 202, namely, the central light-emitting regions C and the symmetrical light-emitting regions A11, to emit light concurrently and thus forming the second light-emitting pattern L12. The third supply power source P13 drives the first, second, and third light-emitting regions 201, 202, 203, namely, the central light-emitting regions C and the symmetrical light-emitting regions A11, A22, to emit light concurrently and thus forming the third light-emitting pattern L13. The fourth supply power source P14 drives the LEDs in all regions including the first to fourth light-emitting regions 201˜204, namely, the central light-emitting regions C and the symmetrical light-emitting regions A11, A22, A33, to emit light concurrently and thus forming the fourth light-emitting pattern L14. Because the second to fourth light-emitting regions 202˜204 according to the present embodiment are arranged symmetrically, as the voltage level is increasing, the light-emitting sequence is from the inside to the outside and thus increasing the brightness gradually. Nonetheless, the present invention is not limited to the embodiment. The light-emitting sequence can be from outside to inside and thus increasing the brightness gradually.

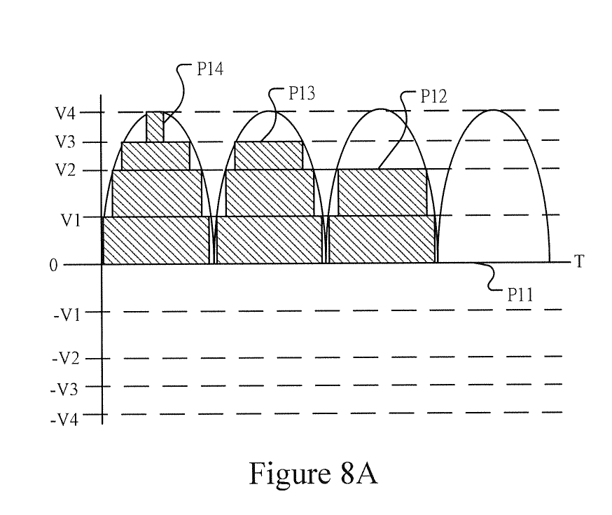

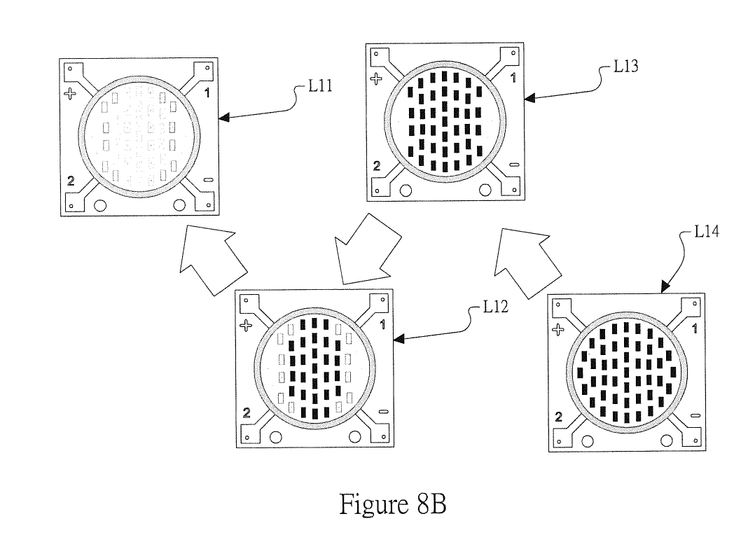

Please refer to FIG. 8A and FIG. 8B, which show schematic diagrams of decreasing voltage levels and variation in the light-emitting regions according to another preferred embodiment of the present invention. The difference between FIG. 7B and FIG. 8B is that the brightness of the light-emitting regions in FIG. 7B are increasing while that in FIG. 8B is decreasing. The light-emitting patterns L11˜L14 in FIG. 8B correspond to the decreasing voltage levels P11˜P14 shown in FIG. 8A.

As shown in FIG. 8A, corresponding to the decreasing voltage levels, the supply power source is changed from the fourth supply power source P14 to the first supply power source P11 gradually. Thereby, the light-emitting regions of the LEDs firstly include the first to fourth light-emitting regions 201˜204 supplied by the fourth supply power source P4, and then reduce gradually to no region emitting light. That is to say, the light-emitting pattern is changed from the fourth light-emitting pattern L14 to the first light-emitting pattern L11 gradually. Because the first to fourth 202-204 light-emitting regions, namely, the light-emitting regions A11, A22, A33, according to the present embodiment are arranged symmetrically, when the voltage is decreasing, light emission stops from the outside to the inside gradually and thus decreasing the brightness. In this way, the power consumption of the light-emitting device 10 can be reduced. According to FIGS. 7A to 8B, the light-emitting device according to the present invention includes at least a pair of symmetrical light-emitting regions for emitting light, which is just the light-emitting pattern L11 and is the power-saving light-emitting pattern.

To sum up, the present invention provides a light-emitting device capable of adjusting brightness. The power control module adjusts the light-emitting regions connected in series with the power source. For different usage requirements in brightness, different light-emitting patterns can be presented and thus achieving different brightness.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A light-emitting device capable of adjusting brightness, comprising:
a substrate;
a plurality of first light-emitting regions, disposed on said substrate;
a plurality of second light-emitting regions, disposed on said substrate, and interlaced with said plurality of first light-emitting regions; and
a power control module, connected electrically with said plurality of light-emitting regions and an input power source, converting said input power source as a first supply power source or a second supply power source, said first supply power source turning on said plurality of first light-emitting regions and enabling said plurality of first light-emitting regions to emit light, and said second supply power source driving said plurality of first light-emitting regions and said plurality of second light-emitting regions to emit light concurrently:
wherein said plurality of first light-emitting regions and said plurality of second light-emitting regions are disposed on said substrate evenly.

2. The light-emitting device of claim 1, wherein said first light-emitting region and said second light-emitting region comprise a plurality of light-emitting diodes, respectively.

3. The light-emitting device of claim 1, and further comprising a plurality of third light-emitting regions and a plurality of fourth light-emitting regions, wherein when the voltage level of said plurality of supply power sources is decreasing sequentially, said plurality of first light-emitting regions to said plurality of fourth light-emitting regions stop emitting light in different regions sequentially and decrease brightness.

4. The light-emitting device of claim 1, and further comprising a plurality of third light-emitting regions and a plurality of fourth light-emitting regions, wherein when the voltage level of said plurality of supply power sources is increasing sequentially, said plurality of first light-emitting regions to said plurality of fourth light-emitting regions emit light in different regions sequentially and increase brightness.

5. The light-emitting device of claim 1, and further comprising a bridge rectifying unit, disposed between an alternate-current power source and said power control module, and rectifying said alternate-current power source for producing a rectified power source to said power control module.

6. The light-emitting device of claim 1, wherein said plurality of first light-emitting regions and said plurality of second light-emitting regions are disposed symmetrically.

7. The light-emitting device of claim 1, wherein said plurality of first light-emitting regions and said plurality of second light-emitting regions are disposed asymmetrically.

8. The light-emitting device of claim 1, wherein said plurality of first light-emitting regions and said plurality of second light-emitting regions are connected electrically in series.

9. A light-emitting device capable of adjusting brightness,
comprising:
a substrate;
a plurality of light-emitting regions, disposed on said substrate, and arranged symmetrically; and
a power control module, connected electrically with said plurality of light-emitting regions and an input power source, converting said input power source to a plurality of supply power sources, supplying power source to at least one pair of said plurality of supply power sources for said plurality of light-emitting regions and thus driving at least one pair of said corresponding light-emitting region to emit light symmetrically
wherein said plurality of light-emitting regions are disposed on said substrate evenly.

10. The light-emitting device of claim 9, wherein said plurality of light-emitting regions comprise a plurality of light-emitting diodes, respectively.

11. The light-emitting device of claim 9, wherein when the voltage level of said plurality of supply power sources is increasing sequentially, said plurality of light-emitting regions emit light in different regions sequentially and increase brightness.

12. The light-emitting device of claim 9, wherein when the voltage level of said plurality of supply power sources is decreasing sequentially, said plurality of light-emitting regions stop emitting light in different regions sequentially and decrease brightness.

13. The light-emitting device of claim 9, and further comprising a bridge rectifying unit, disposed between an alternate-current power source and said power control module, and rectifying said alternate-current power source for producing a rectified power source to said power control module.

14. The light-emitting device of claim 9, wherein said plurality of light-emitting regions are connected electrically in series.
